(19) United States
(12) Patent Application Publication
(10) Pub. No.: US 2017/0004531 A1
(43) Pub. Date: Jan. 5, 2017

(54) ADVERTISEMENT SELECTION USING INFORMATION RETRIEVAL SYSTEMS

(71) Applicant: LinkedIn Corporation, Mountain View, CA (US)

(72) Inventors: Gururaj Seetharama, San Jose, CA (US); Apurva Rajiv Mehta, Mountain View, CA (US); Dmytro Andriyovich Ivchenko, Mountain View, CA (US); Sriram Sankar, Palo Alto, CA (US); Swetha Nagabhushan Karthik, Sunnyvale, CA (US); Christos Koufogiannakis, Menlo Park, CA (US)

(21) Appl. No.: 14/788,600

(22) Filed: Jun. 30, 2015

(51) Int. Cl. G06Q 30/02; G06F 17/30

(52) U.S. Cl. CPC G06Q 30/0256; G06F 17/30867

(57) ABSTRACT

Disclosed in some examples are methods, systems, and machine readable mediums which allow for fast and efficient advertisement selection using search indices. Selection criteria of the advertisement campaigns are converted into documents using a conversion schema. The documents are then indexed to create an advertising campaign index. Member profile data is then converted into a member search query using the conversion schema. The member search query is then issued to a search engine which uses the advertising campaign index to find matching campaigns.

### BACKGROUND

A social networking service is a computer or web-based service that enables users to establish links or connections with persons for the purpose of sharing information with one another. Some social network services aim to enable friends and family to communicate and share with one another, while others are specifically directed to business users with a goal of facilitating the establishment of professional networks and the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a flowchart of a method of selecting advertisement campaigns according to some examples of the present disclosure.

FIG. 2 is a schematic of a social networking service according to some examples of the present disclosure.

FIG. 3 is a block diagram illustrating an example of a machine upon which one or more embodiments may be implemented.

### DETAILED DESCRIPTION

In the following, a detailed description of examples will be given with references to the drawings. It should be understood that various modifications to the examples may be made. In particular, elements of one example may be combined and used in other examples to form new examples.

Many of the examples described herein are provided in the context of a social or business networking website or service. However, the applicability of the inventive subject matter is not limited to a social or business networking service. The present inventive subject matter is generally applicable to a wide range of information and networked services. For example, online job boards where users can view or post resumes and employers can post job openings.

A social networking service is a type of networked service provided by one or more computer systems accessible over a network that allows members of the service to build or reflect social networks or social relations among members. Members may be individuals or organizations. Typically, members construct profiles, which may include personal information such as the member's name, contact information, employment information, photographs, personal messages, status information, multimedia, links to web-related content, blogs, and so on. In order to build or reflect the social networks or social relations among members, the social networking service allows members to identify, and establish links or connections with other members. For instance, in the context of a business networking service (a type of social networking service), a member may establish a link or connection with his or her business contacts, including work colleagues, clients, customers, personal contacts, and so on. With a social networking service, a member may establish links or connections with his or her friends, family, or business contacts. While a social networking service and a business networking service may be generally described in terms of typical use cases (e.g., for personal and business networking respectively), it will be understood by one of ordinary skill in the art with the benefit of Applicant's disclosure that a business networking service may be used for personal purposes (e.g., connecting with friends, classmates, former classmates, and the like) as well as, or instead of, business networking purposes; and a social networking service may likewise be used for business networking purposes as well as or in place of social networking purposes. A connection may be formed using an invitation process in which one member “invites” a second member to form a link. The second member then has the option of accepting or declining the invitation.

In general, a connection or link represents or otherwise corresponds to an information access privilege, such that a first member who has established a connection with a second member is, via the establishment of that connection, authorizing the second member to view or access certain non-publicly available portions of their profiles that may include communications they have authored. Example communications may include blog posts, messages, “wall” postings, or the like. Of course, depending on the particular implementation of the business/social networking service, the nature and type of the information that may be shared, as well as the granularity with which the access privileges may be defined to protect certain types of data may vary.

Some social networking services may offer a subscription or “following” process to create a connection instead of, or in addition to the invitation process. A subscription or following model is where one member “follows” another member without the need for mutual agreement. Typically in this model, the follower is notified of public messages and other communications posted by the member that is followed. An example social networking service that follows this model is Twitter®—a micro-blogging service that allows members to follow other members without explicit permission. Other connection-based social networking services also may allow following-type relationships as well. For example, the social networking service LinkedIn® allows members to follow particular companies.

Network based services such as social networking services and other types of online network services may generate revenue by showing advertising to their users. Advertisers setup advertisings campaign with the network service, the network service then picks an advertisement from one of the advertising campaigns to display to the user. An advertising campaign is defined as one or more advertisement messages that share one or more common characteristics. For example, the one or more advertisements may share a single idea and theme, be aimed at the same group of individuals, and the like. Unlike traditional ad campaigns in traditional media, campaigns setup through network services have the ability to target the users that are exposed to advertisements in the campaign. For example, the user's geographical region may be determined through an internet protocol (IP) address, the user's interests may be ascertained through previous website visits, and the like. The ability to target users is enhanced even further when advertising on a social networking service as the social networking service may have detailed information about their members available through their member profiles. Ad campaigns on social networking services may target a user's location, career, skills, age, gender, geography, and any other attribute stored in the member profile of the social networking service.

With this increased customization of an ad campaign, the computational cost of determining which campaigns to deliver to members also increases. When a member visits a web page of the social networking service that has advertising, current systems iterate through all advertising campaigns looking for advertisement campaigns with targeting criteria that matches attributes in the member's profile. Once the overall group of matching advertisement campaigns is found, the social networking service uses one or more selection algorithms to select among the group of matching advertisement campaigns, and then selects an advertisement from the campaign (e.g., using rules in the campaign to determine which advertisements are shown depending on the various contexts).

As the number of campaigns grows, the time it takes to accomplish this task also grows. Selection of advertisements must be done very quickly as any delay in the advertisement may delay the display of the entire page, causing the system to appear sluggish and decreasing member satisfaction. While the social networking service may display the page first and then render the advertisement last, this is distracting to the member and is considered less effective than advertisements that appear to blend in to the page.

Disclosed in some examples are methods, systems, and machine readable mediums which allow for fast and efficient advertisement campaign selection using one or more search indices. Selection criteria of the advertisement campaigns are converted into documents using a conversion schema. The documents are then indexed to create an advertising campaign index. Member profile attributes are then converted into a member search query using the conversion schema. This conversion of profile data to queries can be done in advance (and updated when profile data changes), or when the social networking service determines that an advertising selection is appropriate for the member (e.g., when the member visits a webpage on the social networking service or navigates to a screen in a mobile application, or the like.) The member search query is then issued to a search engine which uses the advertising campaign index to find matching campaigns.

By indexing the selection criteria and searching based upon the member profile attributes, the search is dependent on the number of possible selection criteria rather than the number of campaigns. The selection criteria are expected to grow much slower than the number of active advertising campaigns.

Selection criteria comprises targeting criteria (e.g., member profile attributes) and context criteria. The targeting criteria include member profile attributes that the advertising campaign is targeting. For example, an advertisement campaign may target members based upon one or more of: age, gender, location, job title, employment history, educational history, and the like. The context criteria specify a context for showing an advertisement from the campaign. A context is the circumstances and properties of the advertisement. For example, the context criteria may include the advertising type (e.g., whether it is a sponsored update, banner advertisement), the type of media (e.g., the advertisement is a video, a static image, audio), how it is to be delivered (email, web page), and other information.

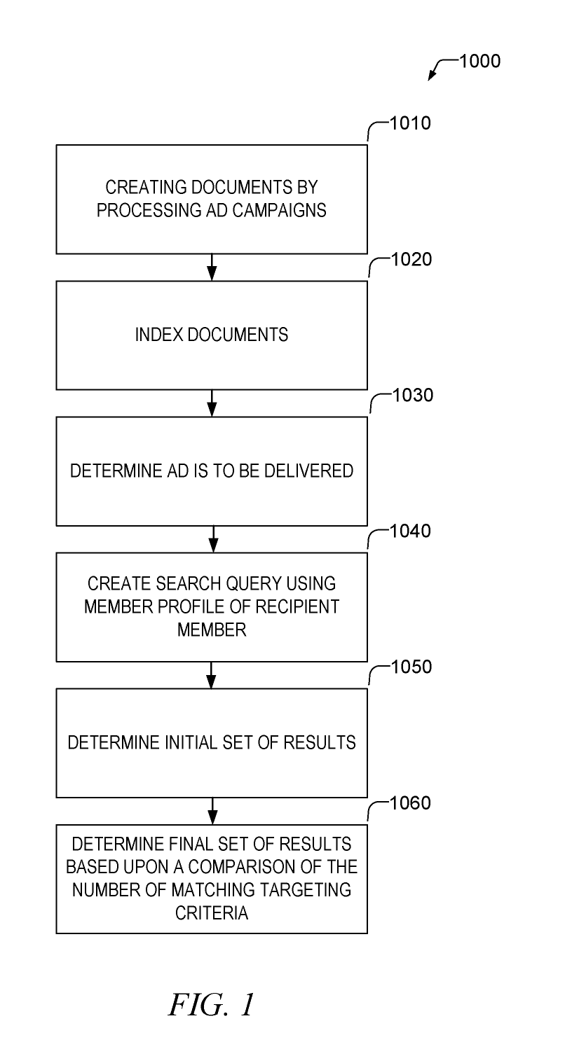

Turning now to FIG. 1, an example flowchart of a method 1000 of selecting advertisement campaigns according to some examples of the present disclosure is shown. At operation 1010 a plurality of documents are created by processing selection criteria in the advertisement campaigns. In some examples, the documents produced are textual documents that are formatted according to a predetermined schema. Consider the following example advertisement campaign selection criteria:

Campaign 1:

Member Targeting Criteria:
Geographical region=California;
Skills=Java;
Company=Acme Packing Company;

Context Criteria:
Type=sponsored update, email advertisement, or banner advertisement;
IsVideo=No;
Budget Completed?=No;

Campaign 2

Member Targeting Criteria:
Geographical region=California;
Title=Software Engineer;

Context Criteria:
Type=sponsored update, email advertisement, or banner advertisement;
IsVideo=No;
Budget Completed?=No;

Campaign 3

Member Targeting Criteria:
Geographical Region=Hawaii;
Gender=Female;
Title=CEO;

Context Criteria:
Type=email advertisement;
IsVideo=Yes;
Budget Completed?=No;

As can be appreciated, campaign 1 targets members in California who are skilled in Java and who work at the Acme Packing Company. Campaign 1 is valid as a sponsored update, email advertisement, or a banner advertisement, campaign 1 is not a video, and the campaign has not reached its budgetary maximum. Campaign 2 targets members in California who are software engineers. Campaign 2 is valid as a sponsored update, email advertisement, or a banner advertisement, campaign 2 is not a video, and the campaign has not reached its budgetary maximum. Campaign 3 targets female members who live in Hawaii and who are a CEO. Campaign 3 is valid as an email advertisement and is or contains a video.

A conversion schema may be utilized to convert the selection criteria (the targeting criteria, the contextual criteria, or both) of each campaign into a particular format, which is then stored as a separate document for each campaign (called a campaign document). For example, the schema may specify that each selection criteria be placed on a separate line of the file, with context criteria first and with the identifier “type=” for the type of advertising, and then “filters:” preceding the rest of the context criteria. The schema may specify that each member targeting criteria be placed next preceded by the identifier “targets:”. Thus, in the above example, the system would generate three separate documents. For example, the first campaign document (d1) would contain: Type=sponsored update Type=email advertisement Type=banner Filters: isVideo=No Filters: BudgetCompleted=No Targets: Geographical Region=California Targets: Skills=Java Targets: Company=Acme Packing Company

The second campaign document (d2) would contain: Type=sponsored update Type=email advertisement Type=banner Filters: isVideo=No Filters: BudgetCompleted=No Targets: Geographical Region=California Targets: Title=Software Engineer

The third campaign document (d3) would contain: Type=email advertisement Filters: isVideo=Yes Filters: BudgetCompleted=No Targets: Geographical Region=Hawaii Targets: Gender=Female Targets: Title=CEO

At operation 1020 an index is created. This index may be an inverted index which is a data structure that maps the terms of the entire set of campaign documents to which campaign documents those terms reside in. For example, an index built using only the three campaign documents might look like: “Type=sponsored update” {d1,d2} “Type=email advertisement” {d1,d2, d3} “Type=banner” {d1, d2} “Filters: isVideo=No” {d1, d2} “Filters: isVideo=Yes” {d3} “Filters: BudgetCompleted=No” {d1, d2, d3} “Targets: Geographical Region=California” {d1, d2} “Targets: GeographicalRegion=Hawaii” {d3} “Targets: Skills=Java” {d1} “Targets: Company=Acme Packing Company” {d1} “Targets: Title=Software Engineer” {d2} “Targets: Title=CEO” {d3} “Targets: Gender=Female” {d3}

This index specifies for each selection criteria, each campaign document that matches.

At operation 1030 the social networking service may determine that an advertisement is to be delivered to a recipient member. This may be as a result of the recipient member visiting a web page on the social networking service that is to have an advertisement from one of the advertising campaigns displayed in it. In other examples, the social networking service may determine that it is an appropriate time to send an email, or some other type of advertisement, to the member.

At operation 1040 the social networking service may create a search query using the member profile attributes of the recipient member. The schema may specify how a query is built from the member profile attributes of the member profile. Additionally, in some examples, the query may also include one or more terms corresponding to the member's current context.

For example, if the member profile has, inter-alia, the following fields with corresponding attributes: Name: Joe Sanders Title: Software Engineer Gender: Male Geographical Region: California Skills: HTML

And the member's current context includes the following fields: Type=sponsored update; Filters=isVideo=false; IsBudgetCompleted=false;

In some examples, the query may be constructed such that all the context criteria of a campaign must be matched by the context of the member for that campaign to be selected. In some examples, this is achieved by use of the logical AND operator to connect terms corresponding to the context criteria. This ensures that the member's context is appropriate for any selected advertisement.

While all the targeting criteria of the campaign must match the corresponding member profile attributes of the member for a campaign to match the member, the reverse is not true. That is, all the member profile attributes need not be targeted for a match to be valid. Thus, while the use of logical AND is acceptable for the context criteria (as the same fields will be in both the member's context information and the context criteria in the advertisement campaign), it is not ideal for use in targeting criteria because it is not likely that an advertisement campaign would specifically target every member profile attribute field possible. For example, if the member profile attributes were all combined with the logical AND operators, only advertising campaigns that specifically targeted ALL of the member profile attributes of a specific member would match.

Thus for example, consider the query: +type=sponsored update+filters:isVideo=false+isBudgetCompleted=false+target:name=JoeSanders+target:title=software engineer+target:gender=male+target: Geographic Region=California +target:skills=HTML Where the ‘+’ sign indicates an AND operator. While the correct result is that campaign 2 matches, the query returns zero results as none of the campaigns targets ALL the member profile attributes. Thus the query undersamples the campaigns.

One method to overcome this problem might be to set a wildcard value in member profile attributes in campaign targeting criteria for which any attribute value would match. This solution would lead to larger campaign files and a correspondingly larger index, which would slow advertisement selection.

Another solution is to combine the targeting criteria according to a logical “OR” operator. Note that the targeting and the context criteria are combined with each other using a logical AND. Consider the query: (+type=sponsored update+filters:isVideo=false+isBudgetCompleted=false+)+(target:name=JoeSanders |target:title=software engineer| target:gender=male |target:Geographic Region=California| target:skills=HTML) Where the T symbol is an “OR” operator, and “(” and “)” symbols specify an order of operations. This query returns all campaigns that meet all the context criteria and any campaign that meets at least one of the targeting criteria. In this case, it would return campaigns 1 and 2. In this case, the query oversamples the campaigns as the member does not meet the targeting criteria of campaign 1 as the member does not have Java skills and is not associated with the Acme Packing Company. This oversample will be corrected in later operations and campaign 1will be removed at that time from the result set.

At operation 1050 the initial set of results are determined. This is done by traversing the query (according to the logical operators in the query) and utilizing the index to determine matching campaigns. In the above example campaigns 1 and 2 would be returned. For example, issuing the query to a search engine along with the indices built at 1020.

As already noted, campaign 1 is not an actual matching campaign as the member does not meet all the targeting criteria, however, the member met at least one of the targeting criteria and by virtue of the operation of the OR logical operator, it matched the initial search. At this point, the search results are post-processed to remove campaigns that are not fully matching. At operation 1060 a final set of results is determined based upon a count of the number of matching query terms for each result. If the number of matching targeting query terms is equal to the number of targeted attributes in the corresponding campaign document, the advertising campaign is considered a match and is included in the final result set.

For example, for campaign 1, there is one matching targeted criteria (geographical region=California) out of a total of three targeted criteria (geographical region, skills, and company). Thus the number of matches (1) between the member query and the campaign document is less than the total number of targeted criteria in the campaign (3) and the result is excluded from the final result set. For campaign 2 there would be two matching targeted criteria (geographical region=California; title=software engineer) out of a total of two targeted criteria (geographical region=California; title=software engineer). Thus, because campaign 2 matched all targeted criteria, it is included in the final result set.

The final result set may then be used to select an advertisement corresponding to a campaign represented by a campaign document in the final result set. In some examples, the advertisement selected from the final result set might be a random selection, in other examples, other selection criteria may be utilized.

In some examples, more sophisticated search algorithms may be utilized. For example, different points may be given for matching different attribute fields and a match may be any campaign that scores over a predetermined threshold. Thus, for example, a campaign may be setup that gives one point for a geographical area match, one point for a gender match and two points for a skills match. Then, any campaign with over two points is considered a match. Thus campaigns that have a skills match but nothing else match, and a campaign with both a geographical area match and a gender match would also be selected. In other examples, ranking and relevance features (e.g., probabilities of a user interacting with the advertisement) may also be factored into the advertisement's selection.

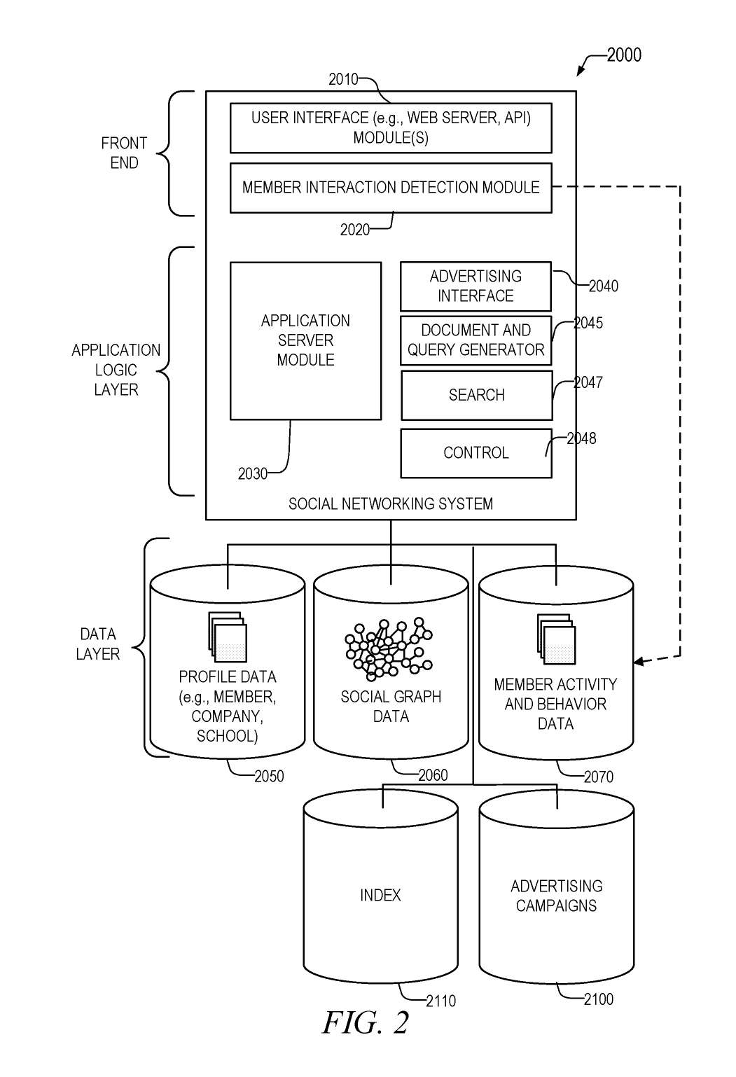

FIG. 2 is a block diagram showing the functional components of a social networking service 2000. As shown in FIG. 2, a front end may comprise a user interface module (e.g., a web server) 2010, which receives requests from various client-computing devices, and communicates appropriate responses to the requesting client devices. For example, the user interface module(s) 2010 may receive requests in the form of Hypertext Transport Protocol (HTTP) requests, or other network-based, application programming interface (API) requests (e.g., from a dedicated social networking service application running on a client device). In addition, a member interaction and detection module 2020 may be provided to detect various interactions that members have with different applications, services and content presented. As shown in FIG. 2, upon detecting a particular interaction, the member interaction and detection module 2020 logs the interaction, including the type of interaction and any meta-data relating to the interaction, in the member activity and behavior database 2070.

An application logic layer may include one or more various application server modules 2030, which, in conjunction with the user interface module(s) 2010, generate various graphical user interfaces (e.g., web pages) with data retrieved from various data sources in the data layer. With some embodiments, application server module 2030 is used to implement the functionality associated with various applications and/or services provided by the social networking service as discussed above.

Application layer may include an advertising interface module 2040 which may create and provide one or more graphical user interfaces to advertisers in conjunction with application server module 2030, and user interface modules 2010. These user interfaces allow for advertisers to enter campaign information and to upload advertisement content to, or create advertisement content on, the social networking service 2000. These user interfaces may allow the advertisers to specify one or more targeted member attributes for their advertisements. Advertisers may also specify some context parameters, such as how much budget to allocate (e.g., corresponding to the isBudgetCompleted context criteria), what types of advertisements they are looking to place (e.g., sponsored update, banner advertisement, email advertisement), and the like. This information may be stored in an advertising campaigns database 2100.

Application layer may also include a document and query generator module 2045 which converts the selection criteria (including the member targeting criteria and the context criteria) of one or more campaigns to one or more campaign documents using the conversion schema. The campaign documents may also be stored in a database such as advertising campaigns database 2100. Document and query generator module 2045 may also convert the member profile attributes and context information of the member to a query string when an advertisement is to be selected for presentation to the member. Contextual information may be generated by the user interface modules 2010 (e.g., upon preparing a web page for the member) or other modules of the social networking service, such as the control module 2048.

Control module 2048 may schedule one or more advertisements for display or presentation to the member. For example control module 2048 may schedule a member to receive an email advertisement. In some examples, document and query generator module 2045 may convert member profile attributes to partial queries prior to a determination that an ad is to be delivered to the member. For example, one or more members of the social networking service may have their member profile attributes converted to partial query strings for faster processing when the need arises. This is because member profile attribute changes may happen infrequently. Note that the query is partial as only the member targeting criteria can be converted to the query as the context information depends on a current context of the user (which is likely to change frequently). At advertisement selection time, the contextual part of the query may be merged with the pre-converted member targeting criteria part. Changes in member profile attributes may result in re-creating the partial query string.

Search module 2047 may build a search index, for example, an inverted index, of the campaign documents created by the document and query generator 2045. The search index may be stored in a database, such as database 2110. Search module 2047 may update the search index as a result of new campaign documents (from newly added campaigns), deleted or expired campaigns, or the like. Search module 2047 may also determine one or more matching campaign documents based upon a query string. For example, search module 2047 may be a search engine.

Control module 2048 may control the process of selecting an advertisement by coordinating the actions of components 2040, 2045, and 2047. For example, control module 2048 may receive a notification from the advertising interface 2040 of a new advertising campaign or a change in an existing advertising campaign. Control module 2048 may prompt the document and query generator 2045 to create or update the campaign document corresponding to that campaign and when the document and query generator 2045 is finished, to notify the search module 2047 to update the search index.

Control module 2048 may receive a notification that an advertisement selection is necessary or may determine itself that a selection is necessary by ascertaining member behavior from the member activity and behavior data 2070 or by communicating with user interface 2010. For example, if a member visits a webpage on which advertising is to be shown, the user interface 2010 may request an ad from control module 2048. Likewise, control module 2048 may determine (e.g., through a timing schedule) when an advertisement is to be delivered to a member (e.g., through an email). Control module 2048 may receive, or procure the member profile attributes and the context information for the recipient member. The control module 2048 may call the document and query generator 2045 to convert the member profile attributes and the contextual information to a query. The control module 2048 may then submit the query to the search module 2047. Search module 2047 may return the initial set of results and information on the number of matching selection criteria for each result in the set of results. While the results are the matching campaign documents, various methods exist for matching the campaign documents to the campaigns they were created from. For example, a filename convention may be used (e.g., the campaign documents may be: campaign_XYZ.txt where XYZ is a unique identification number), a table mapping the campaign documents to the campaigns, metadata stored with the campaign documents, pointers, or the like.

Based upon the information returned from the search module 2047 the control module 2048 will determine the final set of results by determining which campaigns have all selection criteria met by selecting the campaigns where the number of matching selection criteria for that campaign equals the total number of selection criteria specified for the campaign. The control module 2048 may then select one of the advertising campaigns in the final set for presentment to the member. In some examples, sophisticated algorithms may be utilized to select one of the advertising campaigns in the final set, in other examples one is picked at random, and the like.

Index and Advertising Campaign data structures 2100 and 2110 may be part of a data layer which may include several other databases, such as a database 2050 for storing profile data, including both member profile attributes as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 2050. Similarly, when a representative of an organization initially registers the organization with the social networking service, the representative may be prompted to provide certain information about the organization. This information may be stored, for example, in the database 2050, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Information describing the various associations and relationships, such as connections that the members establish with other members, or with other entities and objects are stored and maintained within a social graph in the social graph database 2060. Also, as members interact with the various applications, services and content made available via the social networking service, the members' interactions and behavior (e.g., content viewed, links or buttons selected, messages responded to, etc.) may be tracked and information concerning the member's activities and behavior may be logged or stored, for example, as indicated in FIG. 2 by the member activity and behavior database 2070.

With some embodiments, the social networking system 2000 provides an application programming interface (API) module with the User Interface module 2010 via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

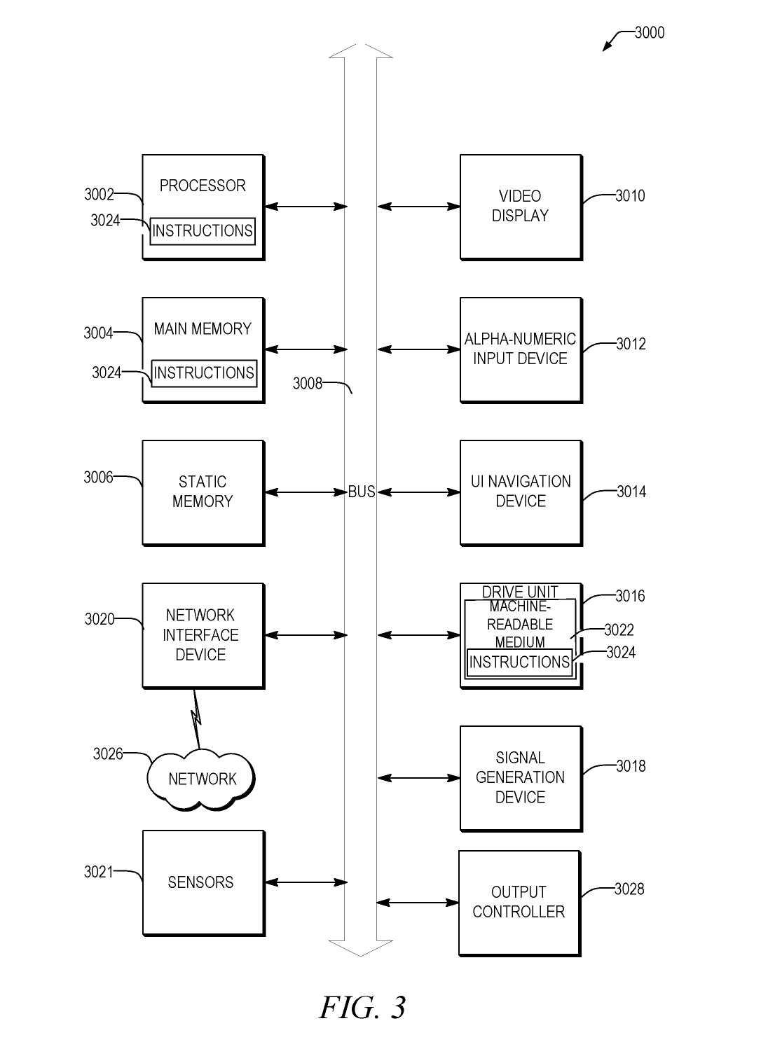

FIG. 3 illustrates a block diagram of an example machine 3000 upon which any one or more of the techniques (e.g., methodologies) discussed herein may perform. In alternative embodiments, the machine 3000 may operate as a standalone device or may be connected (e.g., networked) to other machines. In a networked deployment, the machine 3000 may operate in the capacity of a server machine, a client machine, or both in server-client network environments. In an example, the machine 3000 may act as a peer machine in peer-to-peer (P2P) (or other distributed) network environment. The machine 3000 may implement or include any portion of the social networking service from FIG. 2, and may take the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 3000 may include a hardware processor 3002 (e.g., a central processing unit (CPU), a graphics processing unit (GPU), a hardware processor core, or any combination thereof), a main memory 3004 and a static memory 3006, some or all of which may communicate with each other via an interlink (e.g., bus) 3008. The machine 3000 may further include a display unit 3010, an alphanumeric input device 3012 (e.g., a keyboard), and a user interface (UI) navigation device 3014 (e.g., a mouse). In an example, the display unit 3010, input device 3012 and UI navigation device 3014 may be a touch screen display. The machine 3000 may additionally include a storage device (e.g., drive unit) 3016, a signal generation device 3018 (e.g., a speaker), a network interface device 3020, and one or more sensors 3021, such as a global positioning system (GPS) sensor, compass, accelerometer, or other sensor. The machine 3000 may include an output controller 3028, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 3016 may include a machine readable medium 3022 on which is stored one or more sets of data structures or instructions 3024 (e.g., software) embodying or utilized by any one or more of the techniques or functions described herein. The instructions 3024 may also reside, completely or at least partially, within the main memory 3004, within static memory 3006, or within the hardware processor 3002 during execution thereof by the machine 3000. In an example, one or any combination of the hardware processor 3002, the main memory 3004, the static memory 3006, or the storage device 3016 may constitute machine readable media.

While the machine readable medium 3022 is illustrated as a single medium, the term “machine readable medium” may include a single medium or multiple media (e.g., a centralized or distributed database, and/or associated caches and servers) configured to store the one or more instructions 3024.

The term “machine readable medium” may include any medium that is capable of storing, encoding, or carrying instructions for execution by the machine 3000 and that cause the machine 3000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 3024 may further be transmitted or received over a communications network 3026 using a transmission medium via the network interface device 3020. The Machine 2000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 3020 may include one or more physical jacks (e.g., Ethernet, coaxial, or phone jacks) or one or more antennas to connect to the communications network 3026. In an example, the network interface device 3020 may include a plurality of antennas to wirelessly communicate using at least one of single-input multiple-output (SIMO), multiple-input multiple-output (MIMO), or multiple-input single-output (MISO) techniques. In some examples, the network interface device 3020 may wirelessly communicate using Multiple User MIMO techniques.

1. A method comprising:
using one or more computer processors to perform the operations of:
creating a respective plurality of documents by processing targeting criteria corresponding to each of a plurality of advertising campaigns using a schema;
creating an inverted index from the plurality of documents;
determining that an advertisement is to be delivered to a member of a social networking service;
creating a search query using a member profile of the member and the schema, the search query comprising a set of respective query terms corresponding to respective member profile attributes of the member, each query term in the set of respective query terms connected by logical OR operators;
determining, using the inverted index, a result set of documents from the plurality of documents using a search engine, each document in the result set containing a term that matches at least one of the set of respective query terms of the search query, the search engine calculating a number of matching terms between terms in each document in the result set and terms in the search query;
determining a particular document from the result set of documents in which the corresponding number of matching terms for the particular document is equal to the number of targeting criteria in the particular document and
delivering an advertisement that corresponds to the particular document from the result set for delivery to the member.

2. The method of claim 1, wherein creating the respective plurality of documents comprises:
for each particular one of the plurality of advertising campaigns, matching at least one targeting criteria of the particular one of the plurality of advertising campaigns to an entry in the schema;
determining an output string for the at least one targeted criteria from the entry in the schema; and
writing the output string to the respective one of the plurality of documents corresponding to the particular one of the plurality of advertising campaigns.

3. The method of claim 1, comprising:
receiving a new advertising campaign;
creating a new document by processing targeting criteria in the new advertising campaign using the schema; and
updating the inverted index based upon the new document.

4. The method of claim 1, wherein at least one of the targeting criteria is one of: a geography, a skill, a company, a job title.

5. The method of claim 1, wherein a first advertising campaign from the plurality of advertising campaigns includes a first context criteria to display an advertisement corresponding with the first advertising campaign, and wherein creating the search query comprises receiving a context of the member and converting the context of the member into a second set of respective query terms connected with the set of respective query terms by a logical AND operator.

6. The method of claim 5, wherein the context criteria includes one of: a campaign type, a bid type, and a video flag.

7. The method of claim 5, wherein the context includes one of: a requested web page, language, advertising type, and a video flag.

8. A non-transitory machine-readable medium including instructions, when performed by a machine, causes the machine to perform the operations comprising:
creating a respective plurality of documents by processing targeting criteria corresponding to each of a plurality of advertising campaigns using a schema;
creating an inverted index from the plurality of documents;
determining that an advertisement is to be delivered to a member of a social networking service;
creating a search query using a member profile of the member and the schema, the search query comprising a set of respective query terms corresponding to respective member profile attributes of the member, each query term in the set of respective query terms connected by logical OR operators;
determining, using the inverted index, a result set of documents from the plurality of documents using a search engine, each document in the result set containing a term that matches at least one of the set of respective query terms of the search query, the search engine calculating a number of matching terms between terms in each document in the result set and terms in the search query;
determining a particular document from the result set of documents in which the corresponding number of matching terms for the particular document is equal to the number of targeting criteria in the particular document and
delivering an advertisement that corresponds to the particular document from the result set for delivery to the member.

9. The machine-readable medium of claim 8, wherein the operations for creating the respective plurality of documents comprises operations of:
for each particular one of the plurality of advertising campaigns, matching at least one targeting criteria of the particular one of the plurality of advertising campaigns to an entry in the schema;
determining an output string for the at least one targeted criteria from the entry in the schema; and
writing the output string to the respective one of the plurality of documents corresponding to the particular one of the plurality of advertising campaigns.

10. The machine-readable medium of claim 8, wherein the operations comprise:
receiving a new advertising campaign;
creating a new document by processing targeting criteria in the new advertising campaign using the schema; and
updating the inverted index based upon the new document.

11. The machine-readable medium of claim 8, wherein at least one of the targeting criteria is one of: a geography, a skill, a company, a job title.

12. The machine-readable medium of claim 8, wherein a first advertising campaign from the plurality of advertising campaigns includes a first context criteria to display an advertisement corresponding with the first advertising campaign, and wherein the operations of creating the search query comprises operations for receiving a context of the member and converting the context of the member into a second set of respective query terms connected with the set of respective query terms by a logical AND operator.

13. The machine-readable medium of claim 12, wherein the context criteria includes one of: a campaign type, a bid type, and a video flag.

14. The machine-readable medium of claim 12, wherein the context includes one of: a requested web page, language, advertising type, and a video flag.

15. A system comprising:
a processor;
a non-transitory machine-readable medium including instructions, when performed by a machine, causes the machine to perform the operations comprising:
creating a respective plurality of documents by processing targeting criteria corresponding to each of a plurality of advertising campaigns using a schema;
creating an inverted index from the plurality of documents;
determining that an advertisement is to be delivered to a member of a social networking service;
creating a search query using a member profile of the member and the schema, the search query comprising a set of respective query terms corresponding to respective member profile attributes of the member, each query term in the set of respective query terms connected by logical OR operators;
determining, using the inverted index, a result set of documents from the plurality of documents using a search engine, each document in the result set containing a term that matches at least one of the set of respective query terms of the search query, the search engine calculating a number of matching terms between terms in each document in the result set and terms in the search query;
determining a particular document from the result set of documents in which the corresponding number of matching terms for the particular document is equal to the number of targeting criteria in the particular document; and
delivering an advertisement that corresponds to the particular document from the result set for delivery to the member.

16. The system of claim 15, wherein the operations for creating the respective plurality of documents comprises operations of:
for each particular one of the plurality of advertising campaigns, matching at least one targeting criteria of the particular one of the plurality of advertising campaigns to an entry in the schema;
determining an output string for the at least one targeted criteria from the entry in the schema; and
writing the output string to the respective one of the plurality of documents corresponding to the particular one of the plurality of advertising campaigns.

17. The system of claim 15, wherein the operations comprise:
receiving a new advertising campaign;
creating a new document by processing targeting criteria in the new advertising campaign using the schema; and
updating the inverted index based upon the new document.

18. The system of claim 15, wherein at least one of the targeting criteria is one of:
a geography, a skill, a company, a job title.

19. The system of claim 15, wherein a first advertising campaign from the plurality of advertising campaigns includes a first context criteria to display an advertisement corresponding with the first advertising campaign, and wherein the operations of creating the search query comprises operations for receiving a context of the member and converting the context of the member into a second set of respective query terms connected with the set of respective query terms by a logical AND operator.

20. The system of claim 19, wherein the context criteria includes one of: a campaign type, a bid type, and a video flag.

21. The system of claim 19, wherein the context includes one of: a requested web page, language, advertising type, and a video flag.
